(19) United States
(12) Patent Application Publication
(10) Pub. No.: US 2025/0332744 A1
(43) Pub. Date: Oct. 30, 2025

(54) MODULAR DEXTEROUS MULTI-FINGERED MANIPULATOR SYSTEM WITH RECONFIGURABLE JOINT ANGLES AND DESIGN METHOD THEREFOR

(71) Applicants: Robotics Research Center of Yuyao City, Zhejiang (CN); Zhejiang Qiantang Robot and Intelligent Equipment Research Co. LTD, Zhejiang (CN); ZHEJIANG UNIVERSITY, Zhejiang (CN)

(72) Inventors: Li ZHAI, Zhejiang (CN); Anbang ZHAI, Zhejiang (CN); Huixu DONG, Zhejiang (CN); Haiyun ZHANG, Zhejiang (CN); Guodong LU, Zhejiang (CN); Zhenggang LI, Zhejiang (CN)

(73) Assignees: Robotics Research Center of Yuyao City, Zhejiang (CN); Zhejiang Qiantang Robot and Intelligent Equipment Research Co. LTD, Zhejiang (CN); ZHEJIANG UNIVERSITY, Zhejiang (CN)

(21) Appl. No.: 18/784,789

(22) Filed: Jul. 25, 2024

(30) Foreign Application Priority Data
Apr. 28, 2024 (CN) 202410521784.6

(51) Int. Cl. B25J 15/10; B25J 9/16; B25J 15/04

(52) U.S. Cl. CPC B25J 15/10; B25J 9/1605; B25J 15/0475

(57) ABSTRACT

A modular dexterous multi-fingered manipulator system with reconfigurable joint angles and a design method therefor are disclosed. Each finger has an independent control transmission assembly, and includes an electric motor, a variable transmission unit, a metacarpophalangeal joint driving unit, and an interphalangeal joint driving unit. The variable transmission unit is connected to an output end of the electric motor, the metacarpophalangeal joint driving unit, and the interphalangeal joint driving unit separately, and the variable transmission unit switches a state to control an output force of the electric motor to be transmitted to the metacarpophalangeal joint driving unit such that angle adjustment of a first knuckle is implemented, or transmitted to the interphalangeal joint driving unit such that angle adjustment of a second knuckle is implemented.

### CROSS-REFERENCE TO RELATED APPLICATION

This application claims the priority benefit of China application serial no. 202410521784.6, filed on Apr. 28, 2024. The entirety of the above-mentioned patent application is hereby incorporated by reference herein and made a part of this specification.

### BACKGROUND

### Technical Field

The present disclosure relates to the technical field of dexterous manipulators of robots, and particularly relates to a modular dexterous multi-fingered manipulator system with reconfigurable joint angles and a design method therefor.

### Description of Related Art

As the robot technology develops, a dexterous manipulator tends to gradually replace a traditional robot end actuator to perform a more complex task. Its flexibility, versatility, perception and freedom degree are greatly improved, and its application field is continuously expanded. Therefore, more extensive operations can be conducted. It has been applied to automatic production lines and assembly processes in various industrial and manufacturing fields. In the era of Industry 4.0, the manufacturing industry is facing diversification, customization, and uncertainty, which makes the dexterous manipulator's demand fluctuate more intensely. Most traditional batch and rigid production systems are specially designed for one or more products. Their mechanical structures, control systems and network systems are mostly designed and deployed in a rigid way. Once a new product needs to be produced or a design of an existing product needs to be adjusted, apparatus and process adjustments are required in a large-scale manner, which generally takes long time and massive resources. This kind of rigid production systems cannot quickly adapt to market changes and individual needs of consumers, which limit flexibility and competitiveness of enterprises. Therefore, a reconfigurable manufacturing method is required, and rapid adjustment and customized production of the production system can be implemented by flexibly combining and updating modules, apparatuses, and control systems.

Reconfigurable manufacturing is a manufacturing method with abilities of rapid reorganization and renewal, which can adjust structures and component units in time. Its core technology is reconfigurability of the system. By recombining, replacing, cutting, nesting and innovating manufacturing apparatuses, functional modules or related assemblies, the system can be reconfigured, updated, function-converted, or output-adjusted, so as to satisfy diversified needs of the market and tasks. With increasing demands for personalized products in the market, a reconfigurable dexterous manipulator tends to gradually support customized production and improve flexibility and adaptability of production lines. Therefore, reconfigurability of the dexterous manipulator is also of great significance in the industrial field. The reconfigurability enables the dexterous manipulator to be reconfigured, so as to adjust its structure and function. Through modular design and configuration, the system can be rapidly adjusted and reorganized, so as to adapt to changes of different tasks and working environments, including grasping, transporting and assembling different objects. This flexibility enables the dexterous manipulator to adapt to diverse production tasks, which improves production efficiency and flexibility, and reduces a production cycle and system upgrading cost. Modular design of components is also very important for development and maintenance of a dexterous manipulator system. It allows a robot system to easily add or replace functions. When a part needs to be maintained or upgraded, the module can be operated independently without interfering with the entire system, which is conducive to rapid diagnosis of a problem. In addition, the modular design is generally accompanied by standardization of components, such that the same functional modules produced by different suppliers can be replaced with each other, which improves accessibility of assemblies. By decomposing a complex system into relatively simple subsystems, overall design difficulty is reduced and optimization of each module is facilitated.

To sum up, modularization and reconfigurability of the dexterous manipulator can make it adapt to diversified tasks, improve production efficiency, and reduce deployment and adjustment costs. It supports customized production, improve production efficiency and flexibility, and satisfies ever-changing market demand. In view of this, the present disclosure provides a design method for a modular dexterous multi-fingered manipulator system with reconfigurable joint angles. The system includes a plurality of reconfigurable modules. By configuring and combining these modules, independent adjustment and safe and flexible clamping of different joint bending angles in each finger are implemented in an under-actuated way. Only a single electric motor is required to satisfy angle free ratios and configuration changes of different joints in fingers of the dexterous manipulator, such that various operation requirements of different types of workpieces are satisfied. Compared with a traditional under-actuated or fully-actuated dexterous manipulator system, the system has advantages of reducing a number of driving units, saving a space in a palm, reducing a weight of a hand, reducing manufacturing cost, etc. Meanwhile, it has advantages of high flexibility, strong adaptability, wide application range, and high resource utilization efficiency, and is suitable for various robot application scenes and other industrial fields in the future.

### SUMMARY

An objective of the present disclosure is to provide a modular dexterous multi-fingered manipulator system with reconfigurable joint angles and a design method therefor, which are of practical significance of the reconfigurable joint angles of a dexterous manipulator for improving universality, flexibility, adaptability and resource utilization efficiency of a manufacturing system. A technical solution used by the present disclosure is as follows.

In a design method for a modular dexterous multi-fingered manipulator system with reconfigurable joint angles, each finger in a manipulator includes a first knuckle connected to a metacarpophalangeal joint and a second knuckle connected to an interphalangeal joint. Each finger has an independent control transmission assembly, which includes an electric motor, a variable transmission unit, a metacarpophalangeal joint driving unit, and an interphalangeal joint driving unit. The variable transmission unit is connected to an output end of the electric motor, the metacarpophalangeal joint driving unit, and the interphalangeal joint driving unit separately. The variable transmission unit switches a state to control an output force of the electric motor to be transmitted to the metacarpophalangeal joint driving unit such that angle adjustment of the first knuckle is implemented, or transmitted to the interphalangeal joint driving unit such that angle adjustment of the second knuckle is implemented.

In the technical solution, further, the variable transmission unit includes a magnetic attraction module and a spline module. When the magnetic attraction module drives the spline module to engage with the metacarpophalangeal joint driving unit and disengage from the interphalangeal joint driving unit, the electric motor drives the metacarpophalangeal joint driving unit to adjust an angle of the first knuckle. When the magnetic attraction module drives the spline module to engage with the interphalangeal joint driving unit and disengage from the metacarpophalangeal joint driving unit, the electric motor drives the interphalangeal joint driving unit to adjust an angle of the second knuckle.

Further, the variable transmission unit includes a first spur gear, a second spur gear, a spline module, a magnetic attraction module, a first connecting rod, and a second connecting rod. One end of the first connecting rod is fixedly connected to an output shaft of the electric motor. The first spur gear axially sleeves the first connecting rod and is rotatable freely relative to the first connecting rod. An end surface of the first spur gear is provided with a spline. The spline module axially sleeves the other end of the first connecting rod. An axial flat key is arranged between the spline module and the first connecting rod. End surfaces of two ends of the spline module are provided with splines respectively. An end surface of the metacarpophalangeal joint driving unit is provided with a spline. The second connecting rod is fixedly connected to the interphalangeal joint driving unit. The second spur gear is axially fixed to the second connecting rod. The first spur gear engages with the second spur gear. The magnetic attraction module is configured to control the spline module to move between a spline end surface of the first spur gear and a spline end surface of the metacarpophalangeal joint driving unit along the first connecting rod and the axial flat key, such that one end of the spline module engages with the end surface of the first spur gear in a splined manner, or the other end of the spline module engages with the end surface of the metacarpophalangeal joint driving unit in a splined manner.

Further, the metacarpophalangeal joint driving unit includes a first worm drive mechanism, which includes a first worm and a first worm gear. One end of the first worm is provided with a spline configured to be connected to the spline module of the variable transmission unit. The first worm gear is regarded as the metacarpophalangeal joint, a worm gear shaft of the metacarpophalangeal joint is fixedly connected to a lower end of the first knuckle.

Further, the interphalangeal joint driving unit includes a second worm drive mechanism and a rack and gear mechanism. The second worm drive mechanism includes a second worm and a second worm gear. One end of the second worm is coaxially and fixedly connected to the second connecting rod of the variable transmission unit. The second worm gear is coaxially fixed to a gear of the rack and gear mechanism. An upper end of a rack of the rack and gear mechanism is hinged to a lower end of the second knuckle, and the lower end of the second knuckle is hinged to an upper end of the first knuckle, such that the interphalangeal joint is formed. The interphalangeal joint driving unit further includes a rack positioning block. The rack positioning block is configured to limit a movement direction and an engagement center distance of the rack, so as to ensure that the rack does not rotate and move sideways, and ensure that the rack and the gear engage with each other all the time.

Further, the interphalangeal joint driving unit includes a second worm drive mechanism, a synchronous belt mechanism, and a gear mechanism. The second worm drive mechanism includes a second worm and a second worm gear. One end of the second worm is coaxially and fixedly connected to the second connecting rod of the variable transmission unit. The second worm gear is coaxially fixed to a first synchronous belt wheel of the synchronous belt mechanism. A second synchronous belt wheel is coaxially fixed to a first gear of the gear mechanism. A gear shaft of a second gear of the gear mechanism is hinged to a lower end of the second knuckle, such that the interphalangeal joint is formed.

Accordingly, the present disclosure further provides a modular dexterous multi-fingered manipulator system with reconfigurable joint angles. Each finger in a manipulator includes a first knuckle connected to a metacarpophalangeal joint and a second knuckle connected to an interphalangeal joint. Each finger has an independent control transmission assembly, which includes an electric motor, a variable transmission unit, a metacarpophalangeal joint driving unit, and an interphalangeal joint driving unit. The variable transmission unit includes a first spur gear, a second spur gear, a spline module, a magnetic attraction module, a first connecting rod, and a second connecting rod. One end of the first connecting rod is fixedly connected to an output shaft of the electric motor. The first spur gear axially sleeves the first connecting rod and is rotatable freely relative to the first connecting rod. An end surface of the first spur gear is provided with a spline. The spline module axially sleeves the other end of the first connecting rod. An axial flat key is arranged between the spline module and the first connecting rod. End surfaces of two ends of the spline module are provided with splines respectively. An end surface of the metacarpophalangeal joint driving unit is provided with a spline. The second connecting rod is fixedly connected to the interphalangeal joint driving unit. The second spur gear is axially fixed to the second connecting rod. The first spur gear engages with the second spur gear. The magnetic attraction module is configured to control the spline module to move along the first connecting rod and the axial flat key, such that one end of the spline module engages with the end surface of the first spur gear in a splined manner, or the other end of the spline module engages with the end surface of the metacarpophalangeal joint driving unit in a splined manner.

Further, the metacarpophalangeal joint driving unit includes a first worm drive mechanism, including a first worm and a first worm gear. One end of the first worm is provided with a spline configured to engage with the spline module of the variable transmission unit. The first worm gear is regarded as the metacarpophalangeal joint, a worm gear shaft of the metacarpophalangeal joint is fixedly connected to a lower end of the first knuckle, such that the metacarpophalangeal joint is driven to move when the electric motor rotates.

The interphalangeal joint driving unit includes a second worm drive mechanism and a rack and gear mechanism. The second worm drive mechanism includes a second worm and a second worm gear. One end of the second worm is coaxially and fixedly connected to the second connecting rod of the variable transmission unit. The second worm gear is coaxially fixed to a gear of the rack and gear mechanism. An upper end of a rack of the rack and gear mechanism is hinged to a lower end of the second knuckle, and the lower end of the second knuckle is hinged to an upper end of the first knuckle, such that the interphalangeal joint is formed.

The interphalangeal joint driving unit includes a second worm drive mechanism, a synchronous belt mechanism, and a gear mechanism. The second worm drive mechanism includes a second worm and a second worm gear. One end of the second worm is coaxially and fixedly connected to the second connecting rod of the variable transmission unit. The second worm gear is coaxially fixed to a first synchronous belt wheel of the synchronous belt mechanism. A second synchronous belt wheel is coaxially fixed to a first gear of the gear mechanism, and a gear shaft of a second gear of the gear mechanism is hinged to a lower end of the second knuckle, such that the interphalangeal joint is formed.

The present disclosure has the beneficial effects.

The present disclosure can implement flexible control of angles between different joints of dexterous multi-fingered manipulator fingers, such that a bending amount of different joints of each finger can be freely adjusted to flexibly adapt to target objects having different shapes and sizes, and application scenes and objects of the dexterous multi-fingered manipulator can be greatly expanded. Meanwhile, a modular design concept can greatly save time, simplify a maintenance process of the system, and reduce overall maintenance cost.

The dexterous multi-fingered manipulator system according to the present disclosure mainly implements independent angle adjustment of a single electric motor for a first joint (that is, the metacarpophalangeal joint) and a second joint (that is, the interphalangeal joint) of each finger with a worm gear-worm, the magnetic attraction module, the spline module, a gear-rack, or the synchronous belt mechanism. Particularly, the internal magnetic attraction module can implement flexible control and free angle adjustment of different finger joints through engagement and disengagement functions. When the magnetic attraction module drives the spline module to engage with a driving unit (that is, the metacarpophalangeal joint driving unit) for controlling the first joint and disengage from a driving unit (that is, the interphalangeal joint driving unit) for controlling the second joint, the electric motor drives the worm gear-worm to start adjusting an angle of the first joint. When the magnetic attraction module drives the spline module to engage with the driving unit for controlling the second joint and disengage from the driving unit for controlling the first joint, the electric motor drives the worm gear-worm to start adjusting an angle of the second joint. Angle adjustment between different joints in the fingers is independent and not coupled, such that operation requirements of different types of workpieces are better satisfied.

In addition, each joint of the present disclosure can also be combined with a spring telescopic module in the middle of a connecting rod, so as to achieve passive flexibility of a finger clamping force. In this way, damages of the fingers or the workpieces caused by an excessive clamping force are avoided, and safer operation is implemented. In addition, in a design process, factors such as material selection, structural design and mechanical analysis need to be considered comprehensively to ensure performance and effects of the reconfigurable joint angles of the dexterous manipulator.

### BRIEF DESCRIPTION OF THE DRAWINGS

FIG. 1 is a schematic diagram of an entire structure of a dexterous multi-fingered manipulator system according to the present disclosure.

FIG. 2 is a schematic diagram of a specific instance of a modular dexterous multi-fingered manipulator with reconfigurable joint angles, which is a schematic structural diagram of the dexterous multi-fingered manipulator with reconfigurable joint angles on the basis of a rack connecting rod transmission principle.

FIG. 3 is a view of another viewing angle of a structure in FIG. 2.

FIG. 4 is a view of an enlarged structure in FIG. 3.

FIG. 5 is a schematic diagram of an action state of a spline module in a structure in FIG. 2.

FIG. 6 is a schematic diagram of a specific instance of a modular dexterous multi-fingered manipulator with reconfigurable joint angles, which is a schematic structural diagram of the dexterous multi-fingered manipulator with reconfigurable joint angles on the basis of a synchronous belt transmission principle.

FIG. 7 is a view of another viewing angle of a structure in FIG. 6.

FIG. 8 is a view of an enlarged structure in FIG. 7.

FIG. 9 is a schematic diagram of an action state of a spline module in a structure in FIG. 6.

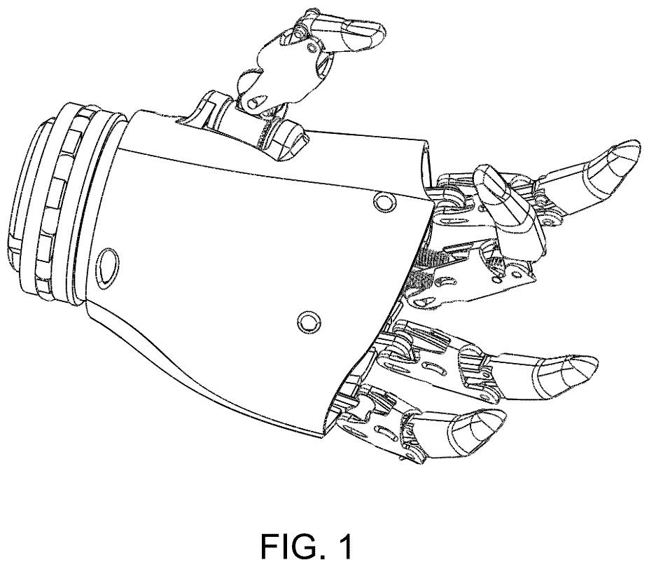

### DESCRIPTION OF THE EMBODIMENTS

To make the above objective, features, and advantages of the present disclosure more obvious and comprehensible, specific embodiments of the present disclosure will be described in detail below with reference to the accompanying drawings. Many specific details are set forth in the following description to facilitate full understanding of the present disclosure. However, the present disclosure can be implemented in many other modes different from those described herein, similar improvements may be made by those skilled in the art without departing from the connotation of the present disclosure, and therefore the present disclosure is not limited by the specific examples disclosed below. The technical features in each example of the present disclosure can be combined accordingly without conflicting with each other.

The present disclosure provides a modular dexterous multi-fingered manipulator system with reconfigurable joint angles. Each finger in a manipulator at least includes a first knuckle connected to a metacarpophalangeal joint 2 and a second knuckle connected to an interphalangeal joint 1. Each finger has an independent control transmission assembly, which includes an electric motor 3, a variable transmission unit, a metacarpophalangeal joint driving unit, and an interphalangeal joint driving unit.

The variable transmission unit includes a first spur gear 7, a second spur gear 18, a spline module, a magnetic attraction module 16, a first connecting rod 20, and a second connecting rod 17. The metacarpophalangeal joint driving unit includes a first worm drive mechanism, which includes a first worm and a first worm gear. The interphalangeal joint driving unit includes a second worm drive mechanism, which includes a second worm and a second worm gear. A transmission strategy may be rack connecting rod transmission or synchronous belt wheel transmission.

One end of the first connecting rod 20 is fixedly connected to an output shaft of the electric motor 3. The first spur gear 7 axially sleeves the first connecting rod 20 and is rotatable freely relative to the first connecting rod. An end surface of the first spur gear 7 is provided with a spline. The spline module axially sleeves the other end of the first connecting rod 20. An axial flat key 21 is arranged between the spline module and the first connecting rod. End surfaces of two ends of the spline module are provided with splines respectively. One end of a first worm 10 in the metacarpophalangeal joint driving unit is provided with a spline. The second connecting rod 17 is fixedly connected to the interphalangeal joint driving unit. The second spur gear 18 is axially fixed to the second connecting rod 17. The first spur gear 7 engages with the second spur gear 18. The magnetic attraction module 16 is configured to control the spline module to move between a spline end surface of the first spur gear and a spline end surface of the first worm along the first connecting rod and the axial flat key, such that one end of the spline module engages with the end surface of the first spur gear in a splined manner, or the other end of the spline module engages with an end surface of the first worm in the metacarpophalangeal joint driving unit in a splined manner.

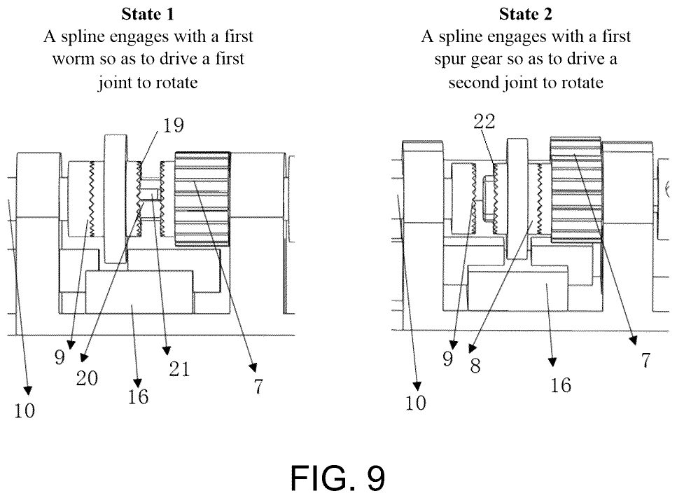

A specific embodiment of the magnetic attraction module may be implemented with a push-pull electromagnet. A push-pull part of the magnetic attraction module is provided with a recess, and a convex part on the spline module is limited in the recess. As shown in FIG. 9, the magnetic attraction module has two working states, that is, state 1 and state 2. When power is turned off, the magnetic attraction module is in an initial position, a square push-pull shaft having the recess on a top of the magnetic attraction module is at a leftmost end, and the magnetic attraction module is in the state 1. In this case, the spline module engages with the first worm, so as to drive a first joint to rotate. When power is turned on, the magnetic attraction module internally generates thrust, the square push-pull shaft having the recess on the top of the magnetic attraction module may be pushed to a right end, and the magnetic attraction module is in the state 2. In this case, the spline module engages with the first spur gear, so as to drive a second joint to rotate.

The variable transmission unit switches a state to control an output force of the electric motor to be transmitted to the metacarpophalangeal joint driving unit such that angle adjustment of the first knuckle is implemented, or transmitted to the interphalangeal joint driving unit such that angle adjustment of the second knuckle is implemented. The system can implement clamping of different types of workpieces with the dexterous multi-fingered manipulator with reconfigurable joint angles in various industrial scenes, so as to ensure universality of the entire dexterous manipulator system.

### Example 1

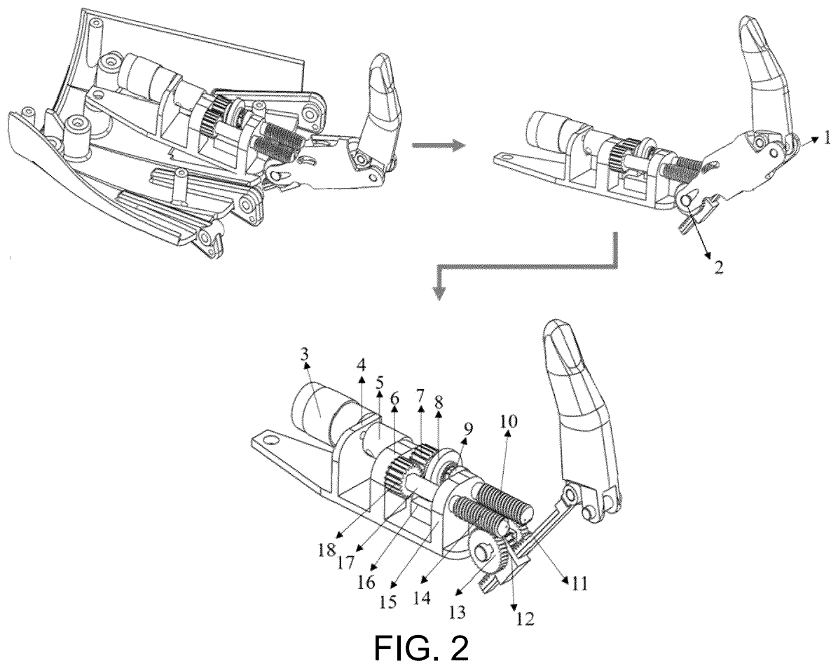

An internal diagram of a modular dexterous multi-fingered manipulator with reconfigurable joint angles on the basis of a rack connecting rod transmission principle is as shown in FIG. 2. In order to show principle details of joint angle adjustment in more details, a middle finger is described in detail herein as an instance. Principles of independent adjustment of joint angles of each finger are similar, so the other fingers will not be repeated herein.

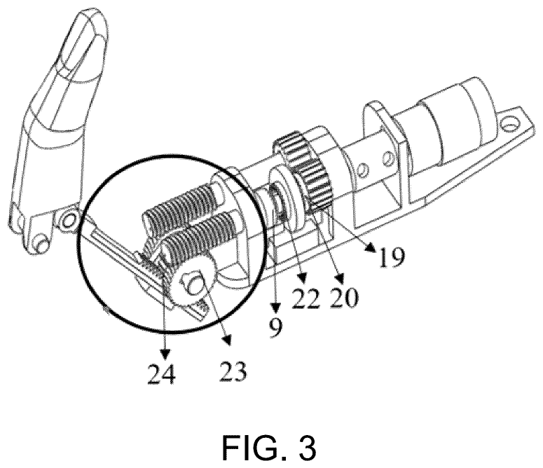

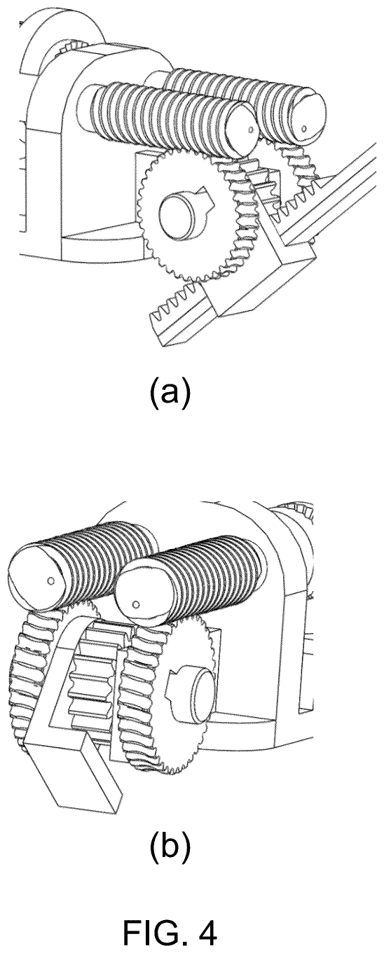

As shown in FIGS. 2-4, the manipulator mainly includes a second joint 1, a first joint 2, an electric motor 3, a first fixing seat 4, a coupler 5, a second fixing seat 6, a first spur gear 7, a first flange plate 8, a second flange plate 9, a first worm 10, a rack connecting rod 11, a rack positioning block 12, a second worm gear 13, a second worm 14, a third fixing seat 15, a magnetic attraction module 16, a second connecting rod 17, a second spur gear 18, a first spline end surface 19, a first connecting rod 20, a flat key 21, a second spline end surface 22, a first worm gear 23, and a gear 24. The first flange plate 8, a first spline end surface 19 and a second spline end surface 22 together constitute a spline module. The first worm 10, the first worm gear 23 and the second flange plate 9 fixed to an end of the first worm 10 together constitute the metacarpophalangeal joint driving unit. An end surface of the second flange plate 9 is provided with a spline. The gear 24 and the rack connecting rod 11 together constitute a rack and gear mechanism, and together constitute the interphalangeal joint driving unit with a worm drive assembly constituted by the second worm gear 13 and the second worm 14. The design method for a modular dexterous multi-fingered manipulator system with reconfigurable joint angles on the basis of a rack connecting rod transmission principle uses a single electric motor to independently and freely adjust bending angles of different joints of dexterous manipulator fingers, such that the manipulator may flexibly, safely and stably operate in various industrial scenes. The method includes the following steps.

1, Firstly, the dexterous manipulator system uses sensors to sense a shape, a size and position information relative to the manipulator of a target object, and plans a safe and efficient trajectory path with the help of a control system. The dexterous manipulator system starts to move according to the planned path and adjusts a posture to prepare for gripping.

2, When a gripper of the dexterous manipulator is accurately aligned with an object, the gripper (finger) of the dexterous manipulator is in a completely open state, and the spline module engages with the first worm 10 of the first joint.

3, The electric motor drives the first worm 10 of the first joint to rotate, and drives the first worm gear 23 engaging with the first worm to rotate. Because the first joint of the finger and the first worm gear are fixedly connected into a whole, the first joint of the finger starts to bend inward from an original completely-flattened state until the first joint moves to a desired angle q1, and the first joint is slowly closed, such that the object is preliminarily fixed.

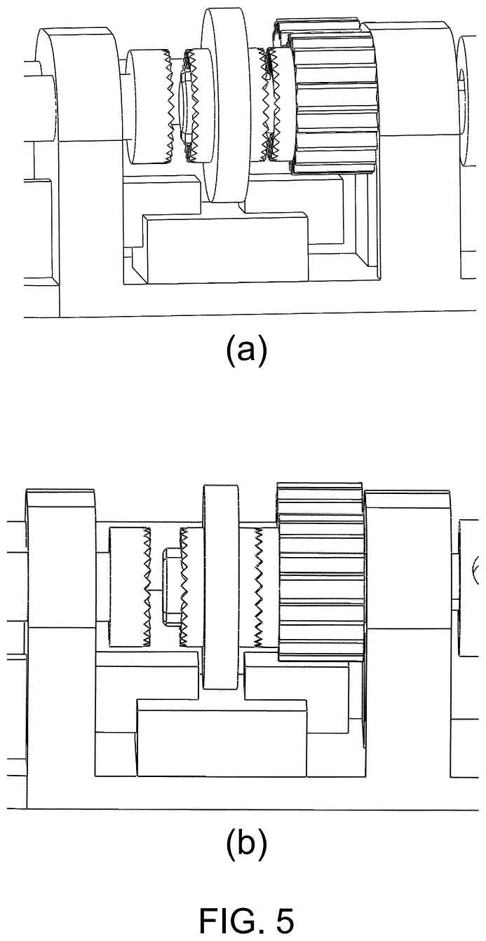

4, When the control system transmits a movement instruction to the magnetic attraction module 16, the magnetic attraction module 16 drives the spline module on the first connecting rod 20 to move axially, that is, to move away from the second flange 9 on a tail end of the first worm 10 of the first joint, until the spline module disengages from an end surface of the second flange plate 9 on the tail end of the first worm 10 of the first joint (as shown in FIG. 5).

5, Under a self-locking effect of the worm gear and the worm, the spline module disengages from the end surface of the flange plate 9 on the tail end of the first worm 10 of the first joint, and the first joint keeps the desired angle q1 unchanged in the entire process.

6, Then, the magnetic attraction module 16 drives the spline module to engage with the spline on the end surface of the first spur gear 7. When the first spur gear 7 keeps engaging with the second spur gear 18 for driving the second joint all the time, the second spur gear 18 starts to drive the second worm 14 of the second joint to move.

7, The second worm 14 in the second joint drives the second worm gear 13 to rotate. The second worm gear 13 drives the gear 24 coaxially connected to the second worm gear to rotate. The gear 24 drives the rack connecting rod 11 connected to a rotating shaft of the second joint to conduct telescopic reciprocating motion until the second joint moves to a desired angle q2.

8, After angles of the first joints and the second joints in the fingers are properly adjusted, the fingers may stably grip the target object. Meanwhile, a worm drive assembly in the dexterous manipulator system has a self-locking function, that is, the desired angles q1 and q2 of the first joints and the second joints of the fingers are kept, such that the target object can be prevented from being damaged or slipping.

9, According to the shape and texture of the object, the remaining fingers in the dexterous manipulator system may also be finely adjusted according to the above process, such that the object is safely and reliably gripped with finer angles.

10, In each subsequent gripping process, the above steps may be repeated.

### Example 2

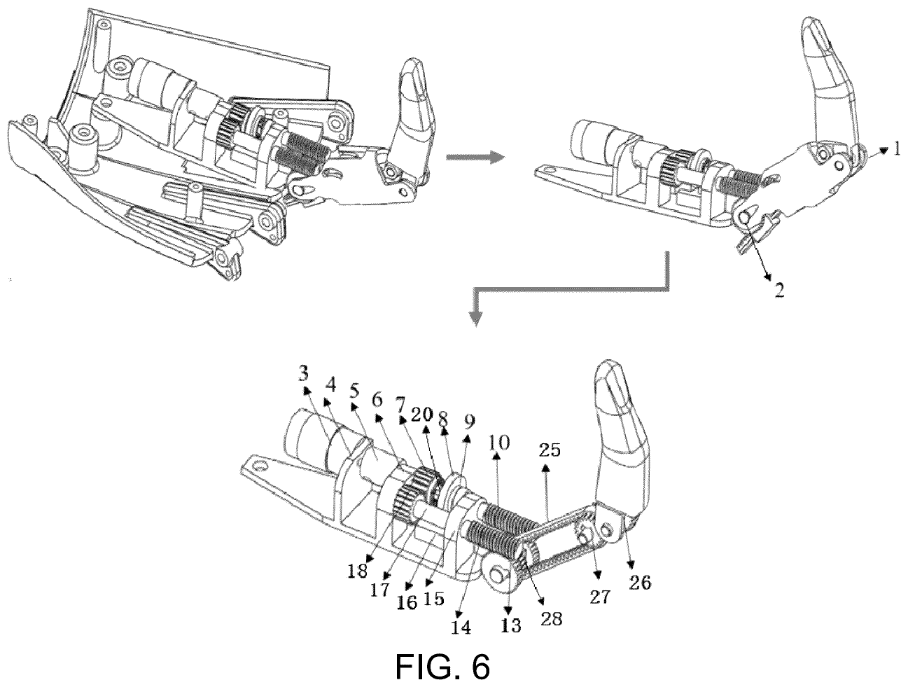

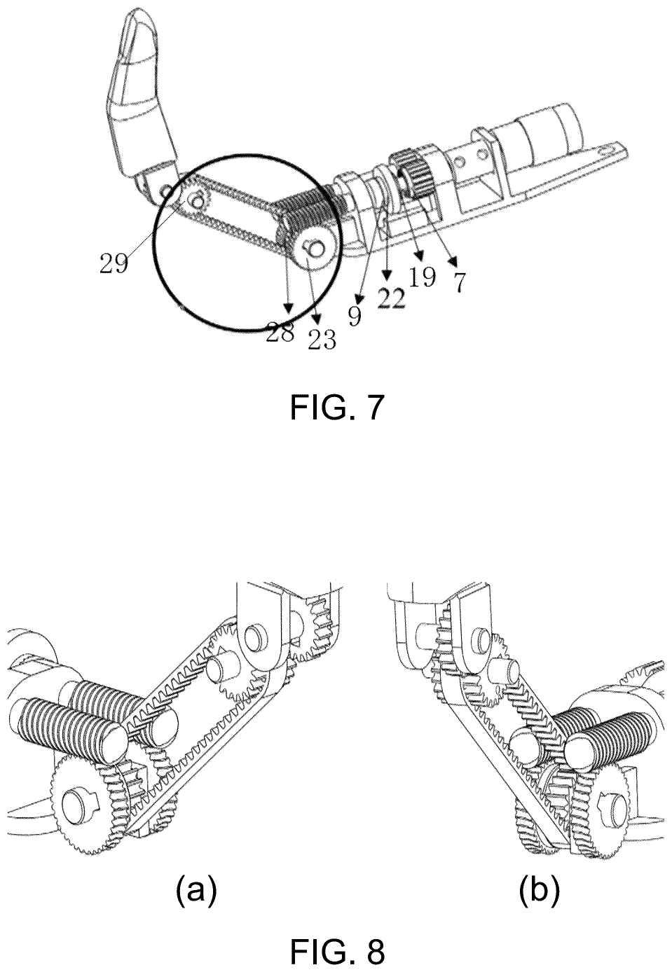

An internal diagram of a modular dexterous multi-fingered manipulator with reconfigurable joint angles on the basis of a synchronous belt transmission principle is as shown in FIG. 6. In order to show principle details of joint angle adjustment in more details, a middle finger is also described in detail herein as an instance. Principles of independent adjustment of joint angles of each finger are similar, so the other fingers will not be repeated herein. The manipulator mainly includes a second joint 1, a first joint 2, an electric motor 3, a first fixing seat 4, a coupler 5, a second fixing seat 6, a first spur gear 7, a first flange plate 8, a second flange plate 9, a first worm 10, a synchronous belt 25, a second gear 26, a second synchronous belt wheel 27, a second worm gear 13, a second worm 14, a third fixing seat 15, a magnetic attraction module 16, a second connecting rod 17, a second spur gear 18, a first spline end surface 19, a first connecting rod 20, a flat key 21, a second spline end surface 22, a first worm gear 23, a first synchronous belt wheel 28, and a first gear 29. The first flange plate 8, a first spline end surface 19 and a second spline end surface 22 together constitute a spline module. The first worm 10, the first worm gear 23 and the second flange plate 9 fixed to an end of the first worm 10 together constitute the metacarpophalangeal joint driving unit. An end surface of the second flange plate 9 is provided with a spline. The first synchronous belt wheel 28, the synchronous belt 25, the second synchronous belt wheel 27, the second worm gear 13, and the second worm 14 constitute the interphalangeal joint driving unit together with the first gear 29 and the second gear 26.

The design method for a modular dexterous multi-fingered manipulator system with reconfigurable joint angles on the basis of a synchronous belt transmission principle uses a single electric motor to independently and freely adjust bending angles of different joints of dexterous manipulator fingers, such that the manipulator may flexibly, safely and stably operate in various industrial scenes. The method includes the following steps.

1, Firstly, the dexterous manipulator system uses sensors to sense a shape, a size and position information relative to the manipulator of a target object, and plans a safe and efficient trajectory path with the help of a control system. The dexterous manipulator system starts to move according to the planned path and adjusts a posture to prepare for gripping.

2, When a gripper (finger) of the dexterous manipulator is accurately aligned with an object, the finger of the dexterous manipulator is in a completely open state, and the spline module engages with the first worm 10 of the first joint.

3, The electric motor drives the first worm 10 of the first joint to rotate, and drives the first worm gear 24 engaging with the first worm to rotate. Because the first joint of the finger and the first worm gear are fixedly connected into a whole, the first joint of the finger starts to bend inward from an original completely-flattened state until the first joint moves to a desired angle q1, and the first joint is slowly closed, such that the object is preliminarily fixed.

4, When the control system transmits a movement instruction to the magnetic attraction module 16, the magnetic attraction module 16 drives the spline module on the first connecting rod 20 to move axially, that is, to move away from the second flange 9 on a tail end of the first worm 10 of the first joint, until the spline module disengages from an end surface of the second flange plate 9 on the tail end of the first worm 10 of the first joint (as shown in FIG. 9).

5, Under a self-locking effect of the worm gear and the worm, the spline module disengages from the end surface of the flange plate 9 on the tail end of the first worm 10 of the first joint, and the first joint keeps the desired angle q1 unchanged in the entire process.

6, Then, the magnetic attraction module 16 drives the spline module to engage with the spline on the end surface of the first spur gear 7. When the first spur gear 7 keeps engaging with the second spur gear 18 for driving the second joint all the time, the second spur gear 18 starts to drive the second worm 14 of the second joint to move.

7, The second worm 14 in the second joint drives the second worm gear 13 to rotate. The second worm gear 13 drives the first synchronous belt wheel 28 to rotate. The first synchronous belt wheel 28 drives the first gear 29 by means of the second synchronous belt wheel 27, so as to drive the second gear 26 to rotate. The second gear 26 is fixedly connected to the rotating shaft of the second joint, so as to drive the second joint to move until the second joint moves to the desired angle q2.

8, After angles of the first joints and the second joints in the fingers are properly adjusted, the fingers may stably grip the target object. Meanwhile, a worm drive assembly in the dexterous manipulator system has a self-locking function, that is, the desired angles q1 and q2 of the first joints and the second joints of the fingers are kept, such that the target object can be prevented from being damaged or slipping.

9, According to the shape and texture of the object, the remaining fingers in the dexterous manipulator system may also be finely adjusted according to the above process, such that the object is safely and reliably gripped with finer angles.

10, In each subsequent gripping process, the above steps may be repeated.

The above examples are only some preferred solutions of the present disclosure, which are not intended to limit the present disclosure. Those skilled in the related art can make various changes and modifications without departing from the spirit and scope of the present disclosure. Therefore, all technical solutions obtained by equivalent substitution or equivalent transformation fall within the protection scope of the present disclosure.

What is claimed is:

1. A design method for a modular dexterous multi-fingered manipulator system with reconfigurable joint angles, wherein each finger in a manipulator comprises a first knuckle connected to a metacarpophalangeal joint and a second knuckle connected to an interphalangeal joint; each finger has an independent control transmission assembly including an electric motor, a variable transmission unit, a metacarpophalangeal joint driving unit, and an interphalangeal joint driving unit; and the variable transmission unit is connected to an output end of the electric motor, the metacarpophalangeal joint driving unit, and the interphalangeal joint driving unit separately, and the design method comprising: controlling, by state switching of the variable transmission unit, an output force of the electric motor to be transmitted to the metacarpophalangeal joint driving unit such that angle adjustment of the first knuckle is implemented, or transmitted to the interphalangeal joint driving unit such that angle adjustment of the second knuckle is implemented.

2. The design method for the modular dexterous multi-fingered manipulator system with reconfigurable joint angles according to claim 1, wherein the variable transmission unit comprises a magnetic attraction module and a spline module; when the magnetic attraction module drives the spline module to engage with the metacarpophalangeal joint driving unit and disengage from the interphalangeal joint driving unit, the electric motor drives the metacarpophalangeal joint driving unit to adjust an angle of the first knuckle; and when the magnetic attraction module drives the spline module to engage with the interphalangeal joint driving unit and disengage from the metacarpophalangeal joint driving unit, the electric motor drives the interphalangeal joint driving unit to adjust an angle of the second knuckle.

3. The design method for the modular dexterous multi-fingered manipulator system with reconfigurable joint angles according to claim 1, wherein the variable transmission unit comprises a first spur gear, a second spur gear, a spline module, a magnetic attraction module, a first connecting rod and a second connecting rod;
one end of the first connecting rod is fixedly connected to an output shaft of the electric motor, the first spur gear axially sleeves the first connecting rod and is rotatable freely relative to the first connecting rod, an end surface of the first spur gear is provided with a spline, the spline module axially sleeves the other end of the first connecting rod, an axial flat key is arranged between the spline module and the first connecting rod, end surfaces of two ends of the spline module are provided with splines respectively, an end surface of the metacarpophalangeal joint driving unit is provided with a spline, the second connecting rod is fixedly connected to the interphalangeal joint driving unit, the second spur gear is axially fixed to the second connecting rod, and the first spur gear engages with the second spur gear; and
the magnetic attraction module is configured to control the spline module to move between a spline end surface of the first spur gear and a spline end surface of the metacarpophalangeal joint driving unit along the first connecting rod and the axial flat key, such that one end of the spline module engages with the end surface of the first spur gear in a splined manner, or the other end of the spline module engages with the end surface of the metacarpophalangeal joint driving unit in a splined manner.

4. The design method for the modular dexterous multi-fingered manipulator system with reconfigurable joint angles according to claim 3, wherein the metacarpophalangeal joint driving unit comprises a first worm drive mechanism, the first worm drive mechanism includes a first worm and a first worm gear, one end of the first worm is provided with a spline configured to be connected to the spline module of the variable transmission unit, and the first worm gear is regarded as the metacarpophalangeal joint, a worm gear shaft of the metacarpophalangeal joint is fixedly connected to a lower end of the first knuckle.

5. The design method for the modular dexterous multi-fingered manipulator system with reconfigurable joint angles according to claim 3, wherein the interphalangeal joint driving unit comprises a second worm drive mechanism and a rack and gear mechanism, the second worm drive mechanism includes a second worm and a second worm gear, one end of the second worm is coaxially and fixedly connected to the second connecting rod of the variable transmission unit, the second worm gear is coaxially fixed to a gear of the rack and gear mechanism, an upper end of a rack of the rack and gear mechanism is hinged to a lower end of the second knuckle, and the lower end of the second knuckle is hinged to an upper end of the first knuckle, such that the interphalangeal joint is formed; and
the interphalangeal joint driving unit further comprises a rack positioning block, and the rack positioning block is configured to limit a movement direction and an engagement center distance of the rack, so as to ensure that the rack does not rotate and move sideways, and ensure that the rack and the gear engage with each other all the time.

6. The design method for the modular dexterous multi-fingered manipulator system with reconfigurable joint angles according to claim 3, wherein the interphalangeal joint driving unit comprises a second worm drive mechanism, a synchronous belt mechanism, and a gear mechanism, the second worm drive mechanism includes a second worm and a second worm gear, one end of the second worm is coaxially and fixedly connected to the second connecting rod of the variable transmission unit, the second worm gear is coaxially fixed to a first synchronous belt wheel of the synchronous belt mechanism, a second synchronous belt wheel of the synchronous belt mechanism is coaxially fixed to a first gear of the gear mechanism, a gear shaft of a second gear of the gear mechanism is hinged to a lower end of the second knuckle, such that the interphalangeal joint is formed.

7. A modular dexterous multi-fingered manipulator system with reconfigurable joint angles, wherein each finger in a manipulator comprises: a first knuckle connected to a metacarpophalangeal joint and a second knuckle connected to an interphalangeal joint; each finger has an independent control transmission assembly including an electric motor, a variable transmission unit, a metacarpophalangeal joint driving unit, and an interphalangeal joint driving unit; the variable transmission unit comprises a first spur gear, a second spur gear, a spline module, a magnetic attraction module, a first connecting rod, and a second connecting rod; one end of the first connecting rod is fixedly connected to an output shaft of the electric motor, the first spur gear axially sleeves the first connecting rod and is rotatable freely relative to the first connecting rod, an end surface of the first spur gear is provided with a spline, the spline module axially sleeves the other end of the first connecting rod, an axial flat key is arranged between the spline module and the first connecting rod, end surfaces of two ends of the spline module are provided with splines respectively, an end surface of the metacarpophalangeal joint driving unit is provided with a spline, the second connecting rod is fixedly connected to the interphalangeal joint driving unit, the second spur gear is axially fixed to the second connecting rod, and the first spur gear engages with the second spur gear; and the magnetic attraction module is configured to control the spline module to move along the first connecting rod and the axial flat key, such that one end of the spline module engages with the end surface of the first spur gear in a splined manner, or the other end of the spline module engages with the end surface of the metacarpophalangeal joint driving unit in a splined manner.

8. The modular dexterous multi-fingered manipulator system with reconfigurable joint angles according to claim 7, wherein the metacarpophalangeal joint driving unit comprises a first worm drive mechanism, the first worm drive mechanism includes a first worm and a first worm gear, one end of the first worm is provided with a spline configured to engage with the spline module of the variable transmission unit, and the first worm gear is regarded as the metacarpophalangeal joint, a worm gear shaft of the metacarpophalangeal joint is fixedly connected to a lower end of the first knuckle, such that the metacarpophalangeal joint is driven to move when the electric motor rotates.

9. The modular dexterous multi-fingered manipulator system with reconfigurable joint angles according to claim 7, wherein the interphalangeal joint driving unit comprises a second worm drive mechanism and a rack and gear mechanism, the second worm drive mechanism includes a second worm and a second worm gear, one end of the second worm is coaxially and fixedly connected to the second connecting rod of the variable transmission unit, the second worm gear is coaxially fixed to a gear of the rack and gear mechanism, an upper end of a rack of the rack and gear mechanism is hinged to a lower end of the second knuckle, and the lower end of the second knuckle is hinged to an upper end of the first knuckle, such that the interphalangeal joint is formed.

10. The modular dexterous multi-fingered manipulator system with reconfigurable joint angles according to claim 7, wherein the interphalangeal joint driving unit comprises a second worm drive mechanism, a synchronous belt mechanism, and a gear mechanism, the second worm drive mechanism includes a second worm and a second worm gear, one end of the second worm is coaxially and fixedly connected to the second connecting rod of the variable transmission unit, the second worm gear is coaxially fixed to a first synchronous belt wheel of the synchronous belt mechanism, a second synchronous belt wheel of the synchronous belt mechanism is coaxially fixed to a first gear of the gear mechanism, and a gear shaft of a second gear of the gear mechanism is hinged to a lower end of the second knuckle, such that the interphalangeal joint is formed.
